(19) United States
(12) Patent Application Publication
(10) Pub. No.: US 2017/0244192 A1
(43) Pub. Date: Aug. 24, 2017

(54) SOCKET FOR AN ELECTRICAL PLUG AND FLEXIBLE ELECTRICAL PLUG

(71) Applicant: Thomson Licensing, Issy les Moulineaux (FR)

(72) Inventors: Peter Georg Baum, Hannover (DE); Jens Spille, Hemmingen (DE); Michael Drexler, Gehrdend (DE); Stefan Kubsch, Hohnhorst (DE); Uwe Riemann, Braunscgweig (DE); Michael Arnold, Isernhagen (DE)

(21) Appl. No.: 15/430,114

(22) Filed: Feb. 10, 2017

(30) Foreign Application Priority Data
Feb. 19, 2016 (EP) 16305197.2

(51) Int. Cl. H01R 13/46; H01R 13/03; H01R 24/58; H01R 13/40

(52) U.S. Cl. CPC H01R 13/46; H01R 13/40; H01R 13/03; H01R 24/58; H01R 2107/00

(57) ABSTRACT

The disclosure relates to the field of electrical connectors, in particular phone connectors. The proposal concerns a socket for an electrical plug which comprises two or more electrical contacts being positioned along a longitudinal axis. The socket includes two or more corresponding contact elements. The socket is constructed in such a way that the corresponding contact elements are mounted at the socket along a curved line such that the electrical plug when inserted into the socket will be bent in the form of the curved line. The proposal further concerns a flexible electrical plug having two or more electrical contact elements positioned along a longitudinal axis wherein the contact elements are constructed in a flexible material.

### REFERENCE TO RELATED APPLICATIONS

This application claims the benefit, under 35 U.S.C. §365, of European Application No. 16305197.2, entitled “SOCKET FOR AN ELECTRICAL PLUG AND FLEXIBLE ELECTRICAL PLUG”, filed on 19 Feb. 2016, in English, the contents of which are hereby incorporated by reference in its entirety.

### TECHNICAL FIELD

The disclosure relates to a socket for an electrical plug where the plug comprises two or more electrical contacts positioned on a longitudinal axis. The disclosure also relates to a correspondingly constructed electrical plug.

### BACKGROUND

Electrical plugs which comprise two or more contacts arranged along a longitudinal axis are commonly known in the field of phone connectors, audio connectors, audio plugs or jack plugs. FIG. 1 shows from left to right a 2.5 mm mono plug, a 3.5 mm mono plug, a 3.5 mm stereo plug and a 6.35 mm stereo plug. The two contact elements are called tip and sleeve (TS) in the case of the two mono plugs. For the case of the three stereo plugs the three contact elements are called tip, ring and sleeve (TRS).

FIG. 2 shows a 3.5 mm 4-conductor TRRS phone connector for stereo unbalanced audio signals plus video signals in the OMTP (Open Mobile Terminal Platform) variant. In this variant the tip contact L is for the left audio channel, 1^{st} ring contact R is for the right audio channel, 2^{nd} ring contact AUX is for an aux signal, e.g. microphone signal and the sleeve contact GND is the back line for all signals (common ground).

A good overview about the different existing variants of phone plugs is known from the Wikipedia article named “phone connector (audio)” published in Internet on Feb. 25, 2016 under the link: https://en.wikipedia.org/wiki/Phone connector (audio).

Also cited is the article “Klinkenstecker” published on Wikipedia on Nov. 17, 2015: https://de.wikipedia.org/wiki/Klinkenstecker.

From U.S. Pat. No. 9,142,925 B2 a D-shaped connector plug is known which includes a flexible portion that allows the connector to bend with respect to an insertion axis. The isolation elements may be made of flexible material and some inner elements, too.

The stereo plug is often used for stereo headphones which are to be connected with an audio player like CD player, DVD player, mp3 player, smart phone, Camcorder, digital still camera or the like. Today, new types of headphones are existing which are equipped with a head tracking module. Such head tracking modules detect the movement of the head typically in the form of detecting the azimuth angle in which the user has turned his head and the elevation angle in which the user has turned his head. For a truly immersive audio experience e.g. in the field of virtual surround, the head tracking module monitors the position of the listener's head every 5 ms. For this type of headphones equipped with head tracking module different types of headphone plugs are needed which are equipped with more contact elements. At least two additional contact elements are needed, one for the azimuth signal and another for the elevation signal.

### SUMMARY

Since phone jacks are penetrating the market for virtual surround headphones with head tracking, which are equipped with more contacts elements, and thus are becoming larger in length, there is a need for a corresponding larger socket which sometimes is also called jack socket. At the same time the devices in which these new type of phone sockets will be mounted are becoming smaller in size. Cell phones and mp3 players and portable radios are an example. Therefore, there is a need for a jack socket which is becoming smaller at least what concerns the lengths of the socket for mounting in an audio player device.

Another object of the disclosure is to provide for an electrical socket which offers more freedom in regard to the position where the socket can be placed in the player device.

These and other objects are solved with a socket for an electrical plug according to embodiments of the present disclosure. A corresponding flexible electrical plug is disclosed.

According to an embodiment of the present disclosure, the contact elements of the socket are mounted along a curved line such that said electrical plug when inserted into the socket will be bent in the form of said curved line. This can shorten the socket arrangement in terms of the mounting length. This can also provide for more flexibility in terms of the position in the device where the socket can be placed. For example if the socket is curved to the right, the socket can be placed at a location closer to the left where a component inside the device is positioned such that at this position a socket in the classical straight form could not be placed. Of course a socket could also be curved to the left when to the right where the socket shall be placed a hurdle is located.

An aspect of the disclosure relates to a socket comprising a bendable socket body adapted for an insertion of at least a part of an electrical plug, said part being inserted in said socket body along an insertion line, the socket comprising two or more corresponding contact elements mounted on said bendable socket body along said insertion line.

According to an embodiment of the disclosure, the socket comprises a straight part comprising at least two of said electrical contact elements, said two electrical contact elements being aligned together when said socket is bent, one of said two electrical contact element being a tip electrical contact element.

According to an embodiment of the disclosure, the socket comprises one or more isolation elements which electrically isolate said electrical contact elements against each other.

According to an embodiment of the disclosure, said isolation elements and/or said contact elements are formed in a wedge shape.

According to an embodiment of the disclosure, said isolation elements are part of an isolation body and said contact elements are mounted at the socket each time between two isolation elements.

According to an embodiment of the disclosure, said socket body is bendable in the form of a spiral.

According to an embodiment of the disclosure, said isolation elements and/or said contact elements are formed in such a shape such that said contact elements are mounted in said socket along said curved line. This way it can be easy to assemble the socket from single parts.

According to an embodiment of the disclosure, said isolation elements are part of a curved isolation body and said contact elements are mounted at the socket each time between two isolation elements. This way the assembling of the socket can be even simpler.

According to an embodiment of the disclosure, said contact elements are made of metal in the form of contact springs or spring loaded pins.

According to an embodiment of the disclosure, said curved line is in the form of a spiral. This shape of the socket can help reducing the length and width of the socket in an optimized way.

According to an embodiment of the disclosure, the at least two first contact elements are positioned on a straight line. This way the socket can be made compatible to known mono or stereo jacks which are of smaller length but are rigid.

According to an embodiment of the disclosure, for the corresponding flexible plug, the contact elements are made of a flexible material. This way, said electrical plug when inserted into a socket according to the disclosure can be bent in the form of the curved line of the socket.

According to an embodiment of the disclosure, the plug comprises at least one isolation element for electrically isolating said two or more contact elements against each other, where said at least one isolation element is being made of flexible isolation material, too.

According to an embodiment of the disclosure, a flexible realization of said contact elements is with the help of a braided conductor material, in particular braided metal.

In another embodiment, one or more isolation elements at the sleeve end which will not be bent when the plug is inserted into the curved socket, have a smaller length than the remaining isolation elements at the tip end. This can be advantageous if the plug will be bent strongly when inserted into the curved socket, e.g. if the socket has spiral form.

In a further embodiment of the disclosure, the plug comprising contact elements and/or the isolation elements is flat in one dimension. This supports that the plug will bent easily when inserted into the curved socket. The contact elements and/or the isolation elements may have cuboid form, wherein the cuboid is thin in one dimension. A flat cable can be used for connecting the contact elements inside the plug.

An aspect of the present disclosure relates to a flexible electrical plug comprising two or more electrical contact elements being positioned along a longitudinal axis.

According to an embodiment of the disclosure, said contact elements are constructed in a flexible material, said electrical plug being adapted to be inserted into a bended socket.

According to an embodiment of the disclosure, the contact elements and/or the isolation elements have cuboid form, the cuboid being thin in one dimension.

According to an embodiment of the disclosure, said contact elements are made of a braided conductor material, in particular braided metal.

Another aspect of the disclosure relates to a device comprising a socket according to the present disclosure, according any of its embodiments.

In an embodiment of the disclosure, the device comprises a socket comprising a bendable socket body adapted for an insertion of at least a part of an electrical plug, said part being inserted in said socket body along an insertion line, the socket comprising two or more corresponding contact elements mounted on said bendable socket body along said insertion line, said socket comprising a straight part comprising at least two of said electrical contact elements, said two electrical contact elements being aligned together when said socket is bent, one of said two electrical contact element being a tip electrical contact element.

In a further embodiment of the disclosure, the socket comprises one or more isolation elements which electrically isolate said electrical contact elements against each other.

In a further embodiment of the disclosure, said isolation elements and/or said contact elements are formed in a wedge shape.

In a further embodiment of the disclosure, said isolation elements are part of an isolation body and said contact elements are mounted at the socket each time between two isolation elements.

In a further embodiment of the disclosure, said contact elements are made of metal in the form of contact springs or spring loaded pins.

In a further embodiment of the disclosure, said socket body is bendable in a form of a spiral.

### DRAWINGS

Exemplary embodiments of the present disclosure are shown in drawings and are explained in greater detail in the following description.

In the drawings:

FIG. 1 shows different types of typical existing phone plugs;

FIG. 2 shows a typical 4-conductor TRRS phone plug;

FIG. 3 shows a flexible TRRRRRS headphone plug and the corresponding socket arranged in curved form plus a normal stereo plug for comparison;

FIG. 4 illustrates a socket arranged in spiral form, and

FIG. 5 illustrates a flat form of a flexible headphone plug.

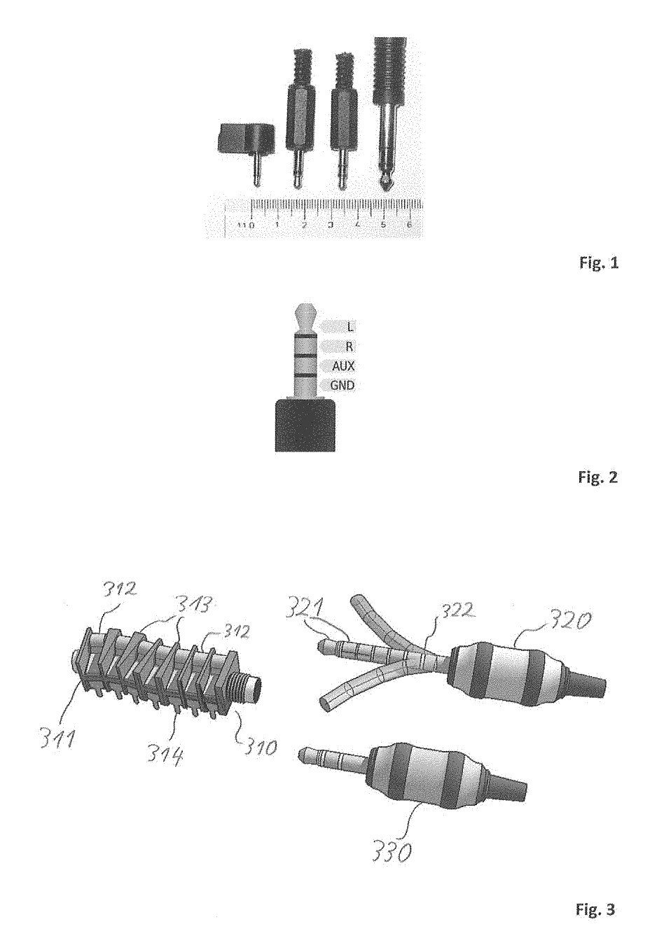

### EXEMPLARY EMBODIMENTS

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

While in the following the electrical socket for a flexible electrical plug are described with sockets and plugs in the field of phone connectors it is made clear that the invention may also be used in other fields of connectors. Some other fields are the wire bus communication in general, the transport of audio and/or video data, control data, and sensor data as an example. Also signals for digital communication as well as signals for analog communication can flow over the connectors according the disclosure.

FIG. 3 shows a first variant of the electrical socket according the disclosure. This variant is labelled with reference number 310. It consists of a socket body 311 which is made of an insulating material. The insulating material may be a rigid elastomer or polyurethane. As an alternative this may also be made of a flexible elastomer e.g. polypropylene or polyoxymethylene. The body of the jack socket also comprises a plurality of isolation elements 313. In the preferred embodiment the isolation elements are an integrated part of the socket body. In an alternative embodiment the isolation elements are separate elements which are attached to the socket body at predefined places. As illustrated in the drawing the isolation elements 313 are wedge shaped. The body of the socket 310 extends in longitudinal direction but is curved in this direction. The isolation elements 313 with wedge shape, are positioned along the curve in equidistance, where the wide end of the wedges are positioned at the outer radius of the curve and the narrow end accordingly at the inner radius. Contact elements 312 made of metal are mounted at the body of the socket each time between two isolation elements 313. Such contact elements 312 preferably have the form of spring contacts or spring loaded contacts. In the embodiment depicted in FIG. 3 the contact elements 312 are inserted into the socket body at the side of the pins 314 of the contact elements 312. All contact elements 312 have the same shape. In a different embodiment the contact elements 312 may have a different shape such as wedge shape for example to support better the curved shape of the socket 310. The pins 314 of the contact elements 312 have the purpose to be soldered on a circuit board (not shown), e.g. printed circuit board PCB. As an alternative they can be used for placing cable contacts over them or even for soldering cables to them if the socket will not be mounted on a circuit board (not shown).

If the body of the socket is made of a flexible material, the socket does not need to be produced in curved shape. The socket will manufactured in the straight line form. When mounted in the device, the socket can be brought into the curved shape form manually. For this it might be needed to heat the socket to a higher temperature so it is easier to bend the socket into the wanted curve shape. Heating could be done with the help of a heating fan for example. When cooling down, the socket remains in the curved form and becomes rigid again.

The first three contact elements of the socket 310 are aligned straight at the socket 310. This has the advantage, that a typical 3.5 mm stereo jack can be inserted into socket 313, too. This way the socket is made compatible to the classical TRS stereo plug.

FIG. 3 depicts the 3.5 mm stereo jack 330 which thus can be inserted into the socket 310, too.

FIG. 3 further depicts a prolonged version of a headphone jack 320. This version comprises contacts 321 in the TRRRRRS format. The thickness is also 3.5 mm. An example of a contact description is provided in the table below:

| Contact | Description |
|---|---|
| Tip | Left Audio Signal |
| Ring | Right Audio Signal |
| Ring | Vcc Supply Voltage |
| Ring | Microphone Signal |
| Ring | Azimuth Signal |
| Ring | Elevation Signal |
| Sleeve | GND Common Ground |

Azimuth signal and elevation signals are signals which the head tracker in the headphone is generating. To work properly the supply voltage for the head tracker is provided by the contact ring 2. In this example the headphone is also comprising a microphone, such that the microphone signal is available on ring 3.

The headphone jack 320 also comprises isolation elements 322 which optionally are made of flexible material, in particular a flexible elastomer or polyurethane, as mentioned above for the socket 310. The contacts 321 of the headphone jack 320 are made of flexible material. A preferred example of a flexible conductor material for the contacts 321 is in the form of braided metal. This way the headphone jack 320 can be bent along the longitudinal direction as indicated in the drawing. In this embodiment the isolation elements 322 have equal length.

In another embodiment the first three isolation elements 322 at the sleeve end of the plug 320 which will not be bent when the plug 320 is inserted into the curved socket 310, have a smaller length than the remaining three isolation elements 322 at the tip end (not shown). This is advantageous if the plug 320 will be bent strongly when the plug is inserted into the curved socket, e.g. if the socket 310 has spiral form.

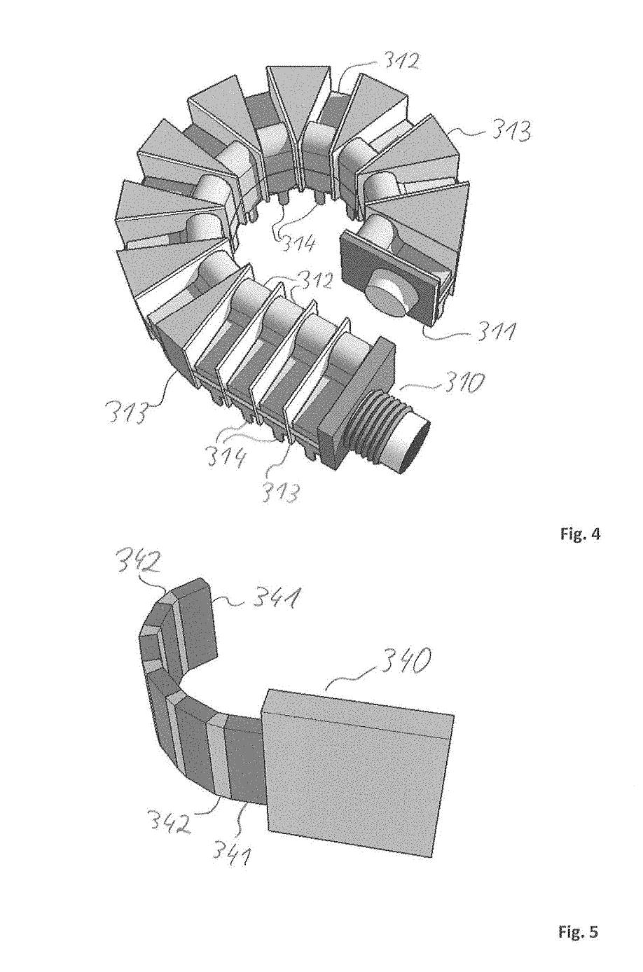

FIG. 4 shows the example of a socket 310 shaped in spiral form, i.e. the curved line has spiral form. This socket arrangement is very compact in size, such that the socket 310 can be mounted in small devices where mounting space is very limited. The first 4 contact elements 312 are positioned on a straight line such that the socket 310 is compatible to TS, TRS, and TRRS plugs.

FIG. 5 shows a flat form of a headphone plug 340. Please note, that the plug 340 is shown in its bent form when inserted into the socket. The plug 340 is straight when not inserted into the socket. The contact elements 341 are not ring contacts and also the isolation elements 342 are not rings. Instead the contact elements 341 and isolation elements 342 have cuboid form. Since the cuboids are thin in one of the three dimensions, the plug 340 is very flexible in this direction and will bent easily when inserted into the corresponding socket (not shown). This construction of the plug therefore allows not to use flexible contact elements 341. It is sufficient to use flexible isolation elements 342. Another advantage is that a flat cable can be used inside the plug 340 for connecting the contact elements 341. As an alternative, other flat forms of contact elements and isolation elements than cuboids will be used.

The disclosure is not restricted to the exemplary embodiments described here. There is scope for many different adaptations and developments which are also considered to belong to the disclosure.

Given the teachings herein, one of ordinary skill in the related art will be able to contemplate similar implementations or configurations of the proposed socket and plug.

1. Socket comprising a bendable socket body adapted for an insertion of at least a part of an electrical plug, said part being inserted in said socket body along an insertion line, the socket comprising two or more corresponding contact elements mounted on said bendable socket body along said insertion line, said socket comprising a straight part comprising at least two of said electrical contact elements, said two electrical contact elements being aligned together when said socket is bent, one of said two electrical contact element being a tip electrical contact element.

2. The socket according to claim 1, comprising one or more isolation elements which electrically isolate said electrical contact elements against each other.

3. The socket according to claim 2, wherein said isolation elements and/or said contact elements are formed in a wedge shape.

4. The socket according to claim 2, wherein said isolation elements are part of an isolation body and said contact elements are mounted at the socket each time between two isolation elements.

5. The socket according to claim 1, wherein said contact elements are made of metal in the form of contact springs or spring loaded pins.

6. The socket according to claim 1, wherein said socket body is bendable in a form of a spiral.

7. Flexible electrical plug comprising two or more electrical contact elements being positioned along a longitudinal axis, wherein said contact elements are constructed in a flexible material, said electrical plug being adapted to be inserted into a bended socket, and wherein the contact elements and/or the isolation elements have cuboid form, the cuboid being thin in one dimension.

8. The flexible electrical plug according to claim 7, wherein said contact elements are made of a braided conductor material.

9. The flexible electrical plug according to claim 7, wherein said contact elements are made of a braided metal.

10. Device comprising a socket comprising a bendable socket body adapted for an insertion of at least a part of an electrical plug, said part being inserted in said socket body along an insertion line, the socket comprising two or more corresponding contact elements mounted on said bendable socket body along said insertion line, said socket comprising a straight part comprising at least two of said electrical contact elements, said two electrical contact elements being aligned together when said socket is bent, one of said two electrical contact element being a tip electrical contact element.

11. The device of claim 10 wherein the socket comprises one or more isolation elements which electrically isolate said electrical contact elements against each other.

12. The device of claim 11 wherein said isolation elements and/or said contact elements are formed in a wedge shape.

13. The device of claim 11 wherein said isolation elements are part of an isolation body and said contact elements are mounted at the socket each time between two isolation elements.

14. The device of claim 10, wherein said contact elements are made of metal in the form of contact springs or spring loaded pins.

15. The device of claim 10 wherein said socket body is bendable in a form of a spiral.
